(19) United States
(12) Patent Application Publication
(10) Pub. No.: US 2016/0364128 A1
(43) Pub. Date: Dec. 15, 2016

(54) DISPLAY CONTROL DEVICE

(71) Applicant: SEIKO EPSON CORPORATION, Tokyo (JP)

(72) Inventor: Tomohiro NAKAGAWA, Matsumoto-Shi (JP)

(73) Assignee: SEIKO EPSON CORPORATION, Tokyo (JP)

(21) Appl. No.: 15/175,309

(22) Filed: Jun. 7, 2016

(30) Foreign Application Priority Data
Jun. 9, 2015 (JP) 2015-116402

(51) Int. Cl. G06F 3/0484; H04N 1/00; G06F 17/21

(52) U.S. Cl. CPC G06F 3/04847; G06F 17/212; G06F 3/04842; H04N 1/00456

(57) ABSTRACT

A printer server includes a display unit that can display a recording region which indicates an area in a continuous paper sheet on which information is recorded and the information to be recorded in the recording region and a display control unit that controls display contents of the display unit. The display control unit causes the display unit to display the recording region and the information in each of a layout view and a pre-view which are display forms different from each other, and causes the display unit to display a slider that can perform an enlargement and reduction operation of the recording region in each of the layout view and the pre-view, and a switching operation between the layout view and the pre-view.

### BACKGROUND

### 1. Technical Field

The present invention relates to a display control device which displays, for example, a user interface in a display unit of a printer server.

### 2. Related Art

A printing system is known in which a printer server interlinks a plurality of host computers and a plurality of printers. In this printing system, when the printer server receives a printing job from a predetermined host computer, the printer server interprets a page description language (PDL) of the printing job, and outputs the printing job as data suitable for a printing-required printer of the printing job among the plurality of printers.

This printing system causes a display device of the printer server to display a thumbnail which indicates a list of printing jobs or a pre-view or the like which indicates image data of printing target data to be printed on a medium as a user interface. A user operates a mouse, a keyboard or the like to confirm the thumbnail or the pre-view in the display device (for example, refer to JP-A-2008-234457).

In JP-A-2008-234457, a slider as the user interface is displayed in the display device along with the thumbnail. An operation of the slider by the user causes the image data of the printing target data of the printing job which is displayed in the thumbnail to be enlarged or reduced. In addition, the image data of printing target data which is indicated in the thumbnail and the image data which is indicated in the pre-view of the image to be printed on the medium can be switched by the operation of the slider.

However, in JP-A-2008-234457, even though the image data of the pre-view can be increased to be larger than the image data of the maximum enlargement rate in the thumbnail by the operation of the slider, the image data of the pre-view itself cannot be enlarged or reduced. Accordingly, there is still room for improvement in the operability of the slider in a case where the user confirms an image in the display unit before printing the image on a medium using a printer. In addition, this problem occurs not only in a case of the thumbnail or the pre-view, but also in a case where the slider is operated with respect to images in different display forms, each of which includes a display region and information and is displayed in the display unit.

### SUMMARY

An advantage of some aspects of the invention is to provide a display control device which is capable of improving the operability of a slider.

Hereinafter, means of the invention and operation effects thereof will be described.

According to an aspect of the invention, there is provided a display control device which includes: a display unit that can display a recording region which indicates an area in a medium in which information is recorded and the information to be recorded in the recording region; and a display control unit that controls display contents of the display unit. The display control unit causes the display unit to display the recording region and the information in each of a first display form and a second display form which are display forms different from each other, and causes the display unit to display a slider that can perform an enlargement and reduction operation of the recording region in each of the first display form and the second display form, and a switching operation between the first display form and the second display form.

According to the above-described configuration, the enlargement and reduction of the recording region in each of the first display form and the second display form, and the switching between the first display form and the second display form are possible by the operation of the slider. Therefore, operability of the slider which is used when image data including the recording region and information are confirmed can be improved.

In addition, in the above-described display control device, it is preferable that the slider includes an operation element that can move by an operation and a slide bar that indicates a movable range of the operation element, and the slide bar is formed with a first slide region as a movable range of the operation element for the enlargement and reduction of the recording region in the first display form, and a second slide region as a movable range of the operation element for the enlargement and reduction of the recording region in the second display form, which are arranged side by side in a row.

According to the above-described configuration, a common slide is used for the enlargement and reduction of the recording region in each of the first display form and the second display form which are display forms of the recording region different from each other. Therefore, it is possible to perform by one slider the enlargement and reduction operation of the recording region in each of the first display form and the second display form. Accordingly, in comparison with a case where the individual slider is displayed in each of the first display form and the second display form, the operability of the enlargement and reduction of the recording region in each of the first display form and the second display form is improved.

In addition, in the above-described display control device, it is preferable that an enlargement and reduction ratio of the recording region per unit movement amount of the operation element in the first slide region is different from an enlargement and reduction ratio of the recording region per unit movement amount of the operation element in the second slide region.

According to the above-described configuration, since the first slide region and the second slide region can be properly used corresponding to a purpose of enlargement or reduction of the recording region or conditions, the operability of the enlargement and reduction of the recording region is improved.

In addition, in the above-described display control device, it is preferable that the enlargement and reduction ratio of the recording region per unit movement amount of the operation element in the second slide region is larger than the ratio in the first slide region, the first display form is a layout view that indicates an arrangement form of the recording region with respect to the medium, and the second display form is a pre-view that indicates detailed information of the recording region.

For example, in the layout view which indicates the arrangement form of a plurality of the recording regions, since the user confirms the arrangement position of the plurality of the recording regions or the orientation of the recording region or the like, it is preferable that the plurality of the recording regions is enlarged or reduced gradually in the layout view. On the other hand, in the pre-view, since the user confirms, for example, details of the information in the recording region, it is preferable that the recording region which is displayed in the pre-view is enlarged or reduced rapidly.

In this respect, according to the above-described configuration, since the recording region of the layout view is operated by the operation element in the first slide region and the recording region of the pre-view is operated by the operation element in the second slide region, the enlargement and reduction ratio of the recording region in the pre-view is larger than the enlargement and reduction ratio of the recording region in the layout view. Accordingly, since the plurality of the recording regions can be enlarged or reduced gradually in the layout view and one recording region can be enlarged or reduced rapidly in the pre-view, the user can easily confirm the arrangement position of the plurality of the recording regions or the orientation of the recording region, and the detailed information in the recording region.

In addition, in the above-described display control device, it is preferable that the display control unit includes a selection unit that can select the recording region which is displayed in the display unit.

According to the above-described configuration, the user can partially or entirely select the recording region which the user wants to confirm, and can be enlarge and reduce the recording region by using the selection unit. For this reason, the user can easily confirm information of the recording region.

In addition, in the above-described display control device, it is preferable that, when the operation element is operated in the first slide region, the display control unit enlarges or reduces the recording region that is displayed in the layout view centering on the recording region which is selected by the selection unit.

According to the above-described configuration, since the recording region which is displayed in the layout view is enlarged and reduced centering on the recording region which the user wants to confirm, for example, after the user enlarges the recording region, the operation which moves the enlarged recording region to a visible region for the user in the layout view can be omitted. For this reason, the user can easily confirm the selected recording region.

In addition, in the above-described display control device, it is preferable that, when the selection unit selects a portion of the recording region that is displayed in the display unit and the operation element is operated in the second slide region, the display control unit enlarges or reduces the recording region that is selected by the selection unit centering on the portion of the recording region which is selected by the selection unit.

According to the above-described configuration, since the recording region is enlarged and reduced centering on a portion of the recording region which the user wants to confirm, for example, after the user enlarges the recording region, the operation which moves the portion of the enlarged recording region to a visible region for the user in the pre-view can be omitted. For this reason, the user can easily confirm a portion which is selected in the recording region.

In addition, in the above-described display control device, it is preferable that the display control unit causes the display unit to display a layout tab which displays the layout view in the display unit and a pre-view tab which displays the pre-view in the display unit, and can switch the layout view and the pre-view based on the selection between the layout tab and the pre-view tab.

According to the above-described configuration, in comparison with the case where the operation of the slider switches the layout view and the pre-view, the layout view and the pre-view can be rapidly switched.

In addition, in the above-described display control device, it is preferable that the display control unit moves the operation element to a position of the slide region corresponding to the selected tab based on the selection between the layout tab and the pre-view tab.

According to the above-described configuration, since the operation which adjusts the position of the operation element after the switching of the layout tab or the pre-view tab can be omitted, the operability of the enlargement and reduction of the recording region by the slider after the switching of the layout tab or the pre-view tab is improved.

In addition, in the above-described display control device, it is preferable that when the layout tab and the pre-view tab are switched, the display control unit moves the operation element step by step to a position of the slide region corresponding to the switched tab.

In a case where the position of the operation element is instantly changed by the switching of the layout tab or the pre-view tab, since it is difficult for the user to grasp whether the operation element is moved or not, it is difficult for the user to grasp whether the position of the operation element corresponding to the layout tab or the pre-view tab is correct or not.

In this respect, according to the above-described configuration, since the operation element is moved step by step when the switching of the layout tab and the pre-view tab is performed, the user can confirm the movement of the operation element, and can easily grasp whether the position of the operation element corresponding to the layout tab or the pre-view tab is correct or not.

In addition, in the above-described display control device, it is preferable that the display control unit sets the display form of the first slide region and the display form of the second slide region to be different from each other.

According to the above-described configuration, the user can easily distinguish the first slide region and the second slide region, and can easily grasp the length of each slide region. For this reason, the user can easily grasp the enlargement and reduction ratio of the recording region with respect to the position of the operation element in each slide region.

### BRIEF DESCRIPTION OF THE DRAWINGS

The invention will be described with reference to the accompanying drawings, wherein like numbers reference like elements.

FIG. 1 is a block diagram illustrating a configuration of an embodiment of a printing system that includes a printer server as an example of a display control device.

FIG. 2 is a schematic diagram illustrating an example of a setting screen that is displayed in a display device of the printer server.

FIG. 3A is a schematic diagram illustrating an example of a layout view before enlarged display, and FIG. 3B is a schematic diagram illustrating an example of the layout view after enlarged display.

FIG. 4A is a schematic diagram illustrating an example of a pre-view before enlarged display, and FIG. 4B is a schematic diagram illustrating an example of the pre-view after enlarged display.

FIG. 5 is a graph illustrating a relationship between a position of an operation element on the layout view and the pre-view, and an enlargement ratio of a recording region.

FIG. 6 is a flow chart illustrating processing procedures of display form change processing.

FIG. 7 is a table illustrating combinations of the positions of the operation element and tabs.

### DESCRIPTION OF EXEMPLARY EMBODIMENTS

Hereinafter, an embodiment of the display control device will be described with reference to the drawings.

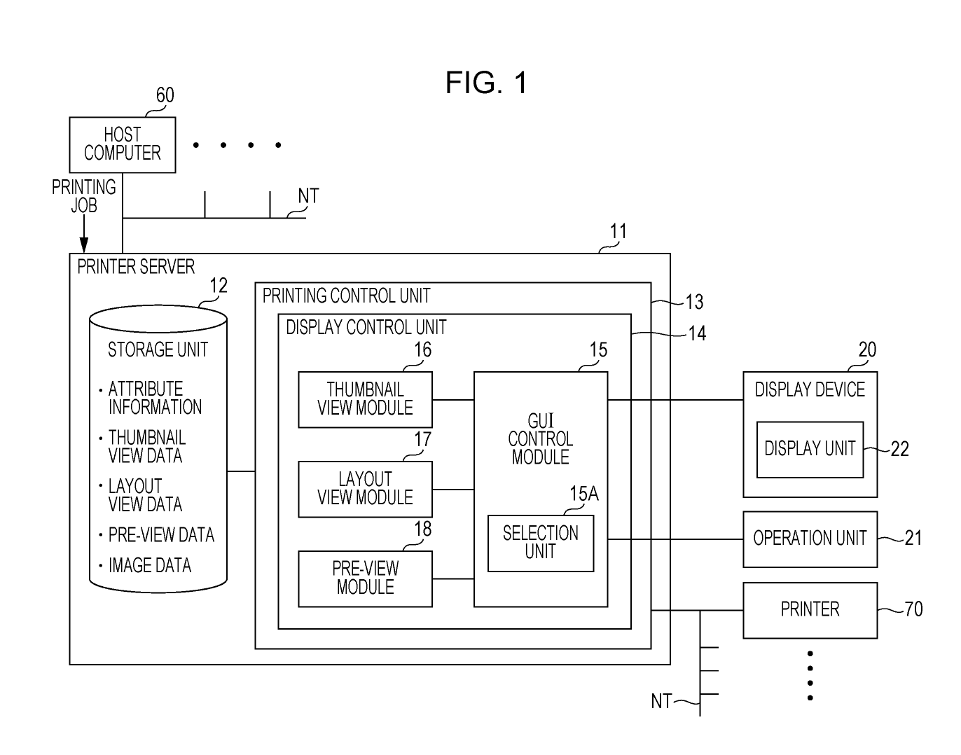

As illustrated in FIG. 1, the printer server 11 as an example of the display control device is a server which is specialized in a printing function, and constitutes a printing system being connected to one or more host computers 60 and one or more printers 70 via a network NT. In addition, the printer 70 of the embodiment is a printer of an ink jet system, but may be a printer of other system than the ink jet system such as a dot impact system, a laser system, and a thermal system or the like as long as the printing on a medium is possible.

The host computer 60 is a host device which performs a printing request with respect to the printer 70. One example of the host computer 60 is a personal computer which has a printing driver corresponding to the printer 70. The host computer 60 generates a printing job via the printing driver and outputs the printing job to the printer server 11. The printing job includes printing information such as a type of continuous paper sheet as an example of a medium, a size of a continuous paper sheet, a layout of an image on the continuous paper sheet, a kind of ink, and color of an image. In addition, the host computer 60 may be a portable terminal such as a smart phone and a Personal Digital Assistants (PDA), instead of the personal computer.

The printer server 11 is configured by a personal computer which includes a display device 20 and an operation unit 21 having a mouse and a keyboard, and is mainly responsible for a function such as interlink of printing processing, image data processing of the printing job (image processing) and accumulation of the processed image data. The printer server 11 interprets a page description language (PDL) of the printing job which is received from the host computer 60 based on the operation of the operation unit 21 by a user and makes data suitable to the printing-required printer 70, and then outputs the data to the printer 70 via the network NT.

The printer server 11 includes a storage unit 12 constituted of an HDD or the like and a printing control unit 13 as an application constituted of a CPU, a ROM, a RAM or the like.

The storage unit 12 stores the printing target data which includes the printing job received from the host computer 60. The printing target data is a target data group of which the printing is instructed by the printing control unit 13, and is constituted by a unit of one image data such as one printing job and a picture from the host computer 60 or the like. Each of these data includes attribute information, thumbnail view data, layout view data, pre-view data, and image data or the like which are linked by identification information. In addition, the image data is the data of an image itself which is the printing target, and for example, is stored as bit map data. The attribute information is the information on image data such as a capacity of data, a data format, and a writer or the like. The view data is the data for displaying an image of the printing target in the display unit 22 of the display device 20, for example, the data obtained by reducing a size of the image data. Herein the image data may be reduced to a similar shape or the like.

The printing control unit 13 has a function which performs an execution process so as to print the printing target data by the printer 70. The printing control unit 13 includes a display control unit 14 which causes the display unit 22 of the display device 20 to display the image data of the printing target data in a plurality of kinds of display formats. Specifically, the display control unit 14 switches and displays a thumbnail view, a layout view, and a pre-view as the plurality of kinds of the display formats in the display unit 22 based on the operation of the operation unit 21 by the user. The thumbnail view displays a reduced-version image of the image data in the printing target data. The layout view enlarges the image data to be larger than in the thumbnail view and displays the layout of an arrangement or an orientation of the image data in the printing target data. The pre-view enlarges the image data to be larger than in the layout view and displays the entire portion of one image data.

The display control unit 14 which controls the display of these various views includes a graphic user interface control module (hereinafter referred to as “GUI control module 15”), a thumbnail view module 16, a layout view module 17, and a pre-view module 18.

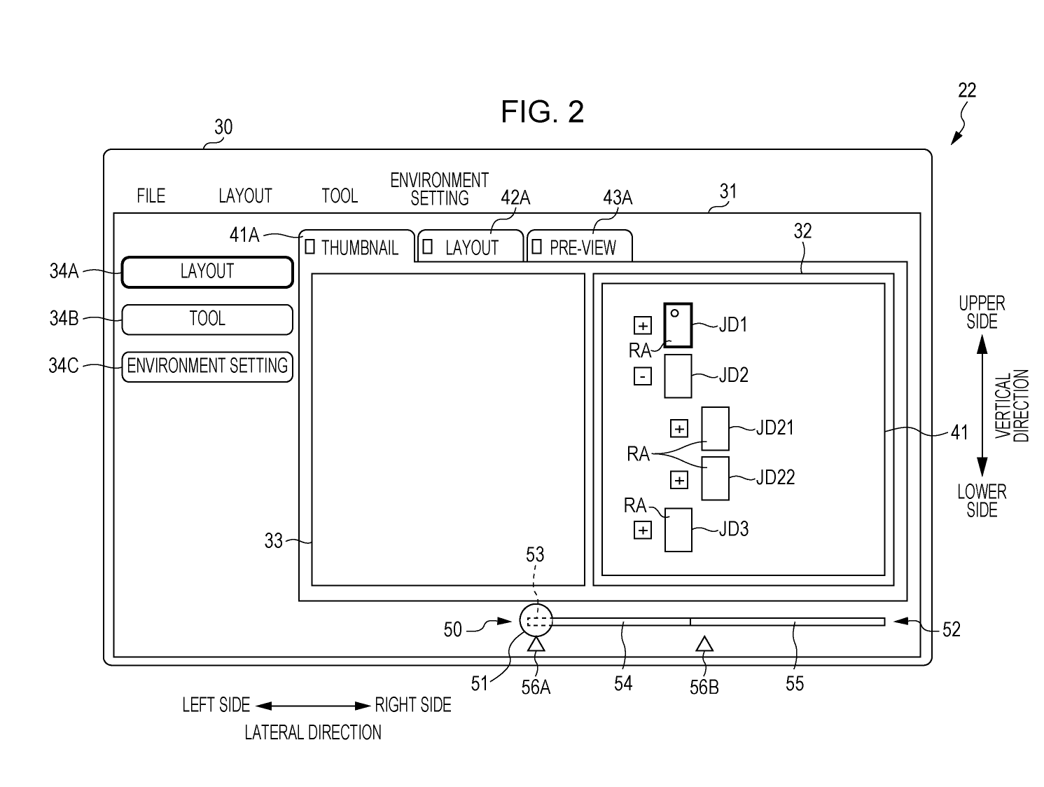

The GUI control module 15 controls the interface for the display of the printing target data and a switching of the display thereof. The GUI control module 15 displays a display window 31 (refer to FIG. 2) which displays the image data of the printing target data by the thumbnail view, the layout view, and the pre-view in the display unit 22, and displays a operation interface of a slider type for the display switching of each view in the display window 31. The GUI control module 15 includes a selection unit 15A which selects predetermined image data in the each view based on the operation of the operation unit 21. The selection unit 15A has a cursor (not illustrated) which is operated by the operation unit 21.

The GUI control module 15 outputs a request signal to the thumbnail view module 16, the layout view module 17, and the pre-view module 18 based on the display request of the thumbnail view, the layout view, and the pre-view which are based on the operation of the operation unit 21.

The thumbnail view module 16, the layout view module 17, and the pre-view module 18 obtain the data required to generate the thumbnail view, the layout view, and the pre-view from the storage unit 12 based on the request signal from the GUI control module 15, and output the data to the GUI control module 15. The GUI control module 15 displays the view in the display window 31 according to the display request of the thumbnail view, the layout view, and the pre-view based on the operation of the operation unit 21.

Next, contents of the each view displayed in the display unit 22 will be described with reference to FIGS. 2 to 4B.

When the user starts the printing control unit 13 as an application by the operation unit 21 (refer to FIG. 1 for both), a setting screen 30 is displayed in the display unit 22, as illustrated in FIG. 2. The items of “file”, “layout”, “tool” and “environment setting” are displayed as menu in the upper side of the setting screen 30. When these items are selected and operated, the contents in accordance with the selected item are displayed in the display window 31. In addition, the “layout” is displayed in the setting screen 30 of FIG. 2.

In the display window 31 in which the item of the “layout” is selected, a view display region 32 in which the image data of the printing target data is displayed in accordance with each tab 41A, 42A, and 43A of the “thumbnail”, “layout”, and “pre-view”, and an operation region 33 which displays editing content capable of being set in each view are displayed side by side in right and left sides of the display window 31. In the left of the operation region 33 in the display window 31, a layout button 34A, a tool button 34B, and an environment setting button 34C are displayed. In addition, when the tool button 34B and the environment setting button 34C are pressed, the contents in accordance with the selected button are displayed in the display window 31. In addition, regardless of which one is selected between the tool button 34B and the “tool” item displayed in the menu, the tool contents are displayed in the display window 31. Furthermore, regardless of which one is selected between the environment setting button 34C and the “environment setting” item, the environment setting contents are displayed in the display window 31.

Since the tab 41A of the “thumbnail” is selected in the display window 31 of the setting screen 30 of FIG. 2, the thumbnail view 41 is displayed in the view display region 32, and the editing contents capable of being set in the thumbnail view 41 (for example, such as movement and deletion of the image data) is displayed in the operation region 33 (not illustrated). The thumbnail view 41 in FIG. 2 is a tree display in which the image data JD1, JD2 and JD3 are arranged side by side with these instructed printing orders from an upper side towards a lower side.

The second image data JD2 from the above in FIG. 2 is hierarchically displayed. That is, the image data JD2 includes image data JD21 and image data JD22 in a lower layer thereof. The positions of the image data JD21 and the image data JD22 in the lateral direction which intersects the vertical direction are arranged to be shifted to the right side of the image data JD2. Therefore it is clearly displayed that the image data JD2 has a hierarchical structure. The image data JD1, JD21, JD22, and JD3 respectively display recording regions RA indicating an area in a continuous paper sheet in which an image as an example of information is recorded. The image to be recorded in the continuous paper sheet is displayed in these recording regions RA. In addition, in FIG. 2, the image data JD1 is selected by the movement of the cursor (not illustrated) in the setting screen 30 based on the operation of the operation unit 21 (refer to FIG. 1). That is, the image data JD1 is selected by the selection unit 15A (refer to FIG. 1). For this reason, in FIG. 2, a frame of the recording region RA of the image data JD1 is indicated by a thick-line.

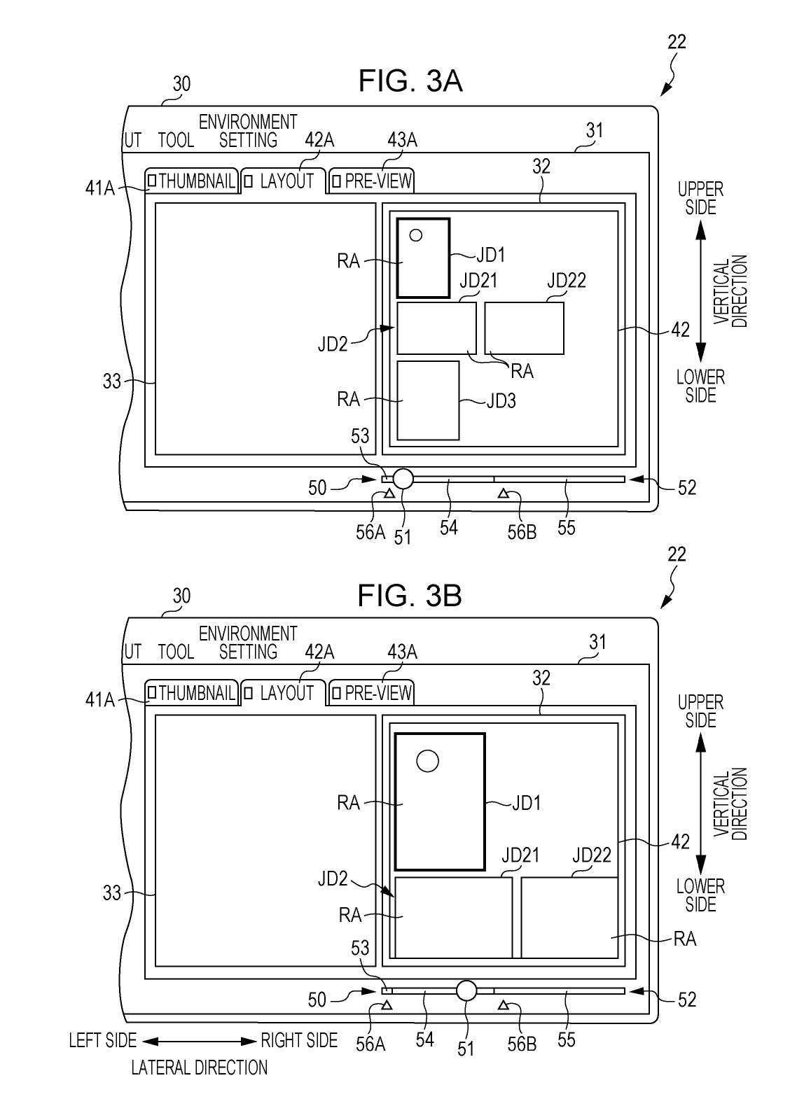

As illustrated in FIG. 3A, when the “layout” tab 42A is selected by the movement of the cursor in the setting screen 30 based on the operation of the operation unit 21 (refer to FIG. 1), the layout view 42 as an example of a first display form is displayed in the view display region 32 on the display window 31. In this case, the editing contents capable of being set in the layout view 42 (for example, such as movement and deletion of the image data) are displayed in the operation region 33. In the layout view 42 of FIG. 3A, the layout of the each recording region RA such as an arrangement position or an orientation or the like of the image data JD1, JD21, JD22, and JD3 is displayed. Specifically, the image data JD1 and JD3 are arranged so that the longitudinal directions of the recording regions RA are along the vertical direction, and the short directions of the recording regions RA are along the lateral direction which intersects the vertical direction. The image data JD21 and JD22 are arranged so that the longitudinal directions of the recording regions RA are along the lateral direction and the short directions are along the vertical direction, and the image data JD21 and JD22 are arranged side by side in the lateral direction.

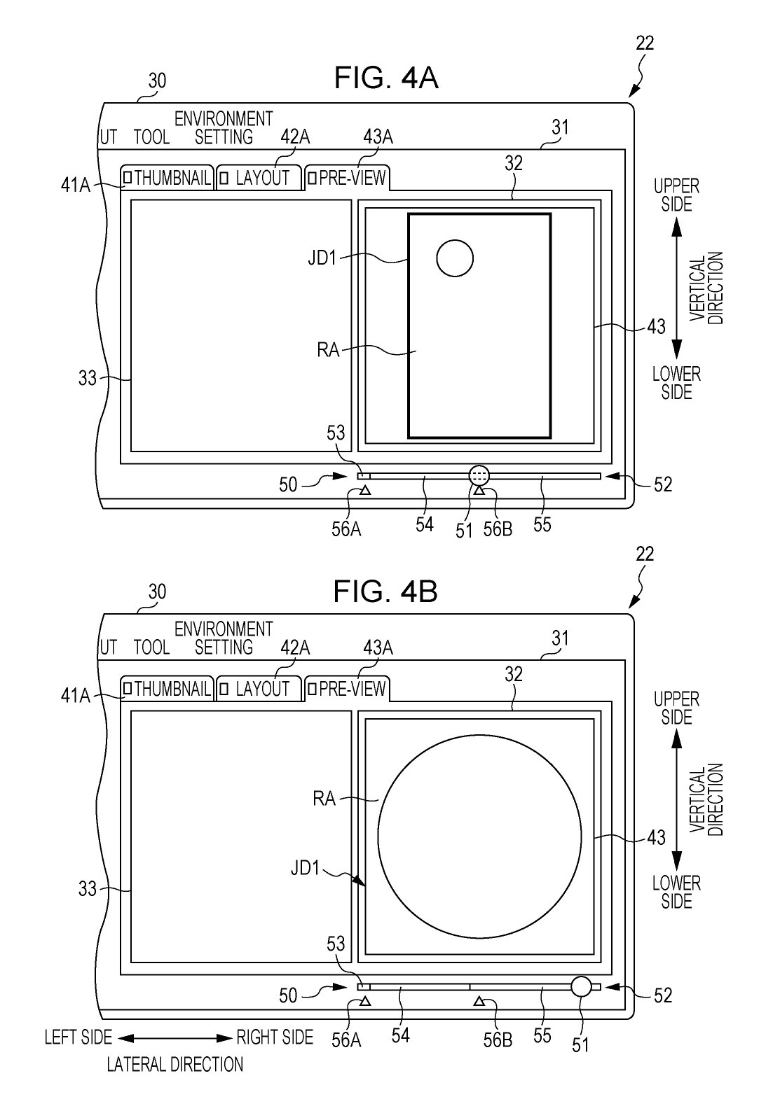

As illustrated in FIG. 4A, when the tab 43A of the “pre-view” is selected by the movement of the cursor in the setting screen 30 based on the operation of the operation unit 21 (refer to FIG. 1), the pre-view 43 as an example of the second display form which is a display form different from the first display form is displayed in the view display region 32 on the display window 31. In this case, the editing contents capable of being set in the pre-view 43 (for example, such as movement and selection of the image data) are displayed in the operation region 33. An enlarged view which entirely indicates the recording region RA of the image data JD1 is displayed in the pre-view 43 of FIG. 4A. In this case, the size of the recording region RA of the image data JD1 in the pre-view 43 is larger than the size of the recording region RA of the image data JD1 in the layout view 42.

Below the view display region 32 in the display window 31 of FIGS. 2 to 4B, a slider 50 as an operation interface for switching between the thumbnail view 41, the layout view 42, and the pre-view 43 and for enlargement and reduction of the recording regions RA of the image data on the layout view 42 and the pre-view 43 is displayed. As illustrated in FIG. 2, the slider 50 includes a circular operation element 51 movable by the operation of the operation unit 21 (refer to FIG. 1) and a slide bar 52 which indicates a movable range of the operation element 51. The slide bar 52 is formed to have a rod shape extending in the lateral direction, and is divided into an end portion region 53 formed on a left end portion, a first slide region 54 formed adjacent to the right portion of the end portion region 53, and a second slide region 55 formed adjacent to the right portion of the first slide region 54. As illustrated in FIG. 2, the slide bar 52 is formed with the end portion region 53, the first slide region 54, and the second slide region 55 which are arranged in a row. The lateral length of the end portion region 53 is shorter than the lateral length of the first slide region 54 and the lateral length of the second slide region 55. The lateral length of the first slide region 54 and the lateral length of the second slide region 55 are equal to each other. According to this configuration of the slider 50, when the user moves the operation element 51 from a left end towards a right end of the slide bar 52, the operation element 51 passes through the end portion region 53, the first slide region 54, and the second slide region 55 in this order. The lateral length of the slide bar 52 is arranged to be equal to the lateral length of the view display region 32, and in a case where the size of the view display region 32 in the lateral direction is changed, the length of the slide bar 52 may be changed in accordance with the size of the view display region 32. In this case, since the lateral size of the view display region 32 and the slide bar 52 change in association with each other, the user is likely to intuitively understand that the slide bar 52 and the view display region 32 have a relation with each other. The slide bar 52 may be arranged with the size which exceeds the lateral size of the view display region 32. In this case, since the movable range of the slide bar 52 is secured widely, the user can easily operate the slide bar 52.

The display form of the end portion region 53, the display form of the first slide region 54, and the display form of the second slide region 55 are different from each other. For example, in the embodiment, with the colors of regions 53 to 55 being different from each other, the display forms of regions 53 to 55 are made different from each other. Specifically, the end portion region 53 is indicated by red, the first slide region 54 is indicated by blue, and the second slide region 55 is indicated by green.

Below the slide bar 52, a position display unit 56A indicating a position of the operation element 51 on the end portion region 53, and a position display unit 56B indicating a central position of the operation element 51 when the operation element 51 is positioned on a left end of the second slide region 55 are displayed.

The first slide region 54 is a movable range of the operation element 51 for the enlargement and reduction of the recording region RA of the image data in the layout view 42. The second slide region 55 is a movable range of the operation element 51 for the enlargement and reduction of the recording region RA of the image data in the pre-view 43. For this reason, when the operation element 51 moves in the first slide region 54 and the second slide region 55, the enlargement and reduction of the recording regions RA of the image data JD1 to JD3 are performed in the layout view 42 centering on the image data which is selected among the image data JD1 to JD3.

Specifically, when the size of the recording regions RA of the image data JD1 to JD3 in a state where the operation element 51 is positioned in a left end of the first slide region 54 as illustrated in FIG. 3A, is a reference size of the layout view 42, as the operation element 51 moves from the left side to the right side as illustrated in FIG. 3B, the size of the recording regions RA of the image data JD1 to JD3 is enlarged to be larger than the reference size. On the other hand, as the operation element 51 moves from the right side to the left side, the recording regions RA of the enlarged image data JD1 to JD3 are reduced towards the reference size. In the embodiment, since the image data JD1 is selected, the recording region RA of each of image data JD1 to JD3 is enlarged and reduced centering on the recording region RA of the image data JD1. When the operation element 51 is positioned in a right end of the first slide region 54, the recording regions RA of the image data JD1 to JD3 on the layout view 42 are maximized. Herein, since the image data JD1 is selected in the embodiment, the image data JD1 is displayed in the view display region 32 illustrated in FIG. 3B. On the other hand, only a portion of the image data JD21 and JD22 is displayed in the view display region 32 illustrated in FIG. 3B, and the image data JD3 (refer to FIG. 3A) is not displayed in the view display region 32 illustrated in FIG. 3B. The image data JD21, JD22 and JD3 can be displayed in the setting screen 30 by scrolling of the view display region 32 to the lower side.

As illustrated in FIG. 4A, in a state where the image data JD1 is selected, the user can select a predetermined image region as a portion of the image data JD1 by movement of the cursor in the setting screen 30 based on the operation of the operation unit 21 (refer to FIG. 1). In FIG. 4A, the image region which includes a circular image is selected as the predetermined image region. In this manner, the selection unit 15A can select a portion of the image data JD1.

When the size of the recording region RA of the image data JD1 in a state where the operation element 51 is positioned in a left end of the second slide region 55 as illustrated in FIG. 4A is a reference size of the pre-view 43, as the operation element 51 moves from the left side to the right side as illustrated in FIG. 4B, the size of the recording region RA of the image data JD1 is enlarged to be larger than the reference size. On the other hand, as the operation element 51 moves from the right side to the left side, the recording region RA of the enlarged image data JD1 is reduced towards the reference size. When the operation element 51 is positioned in the right end of the second slide region 55, the recording region RA of the image data JD1 on the pre-view 43 is maximized. In the embodiment, since the image region which includes the circular image is selected, the image data JD1 is enlarged and reduced centering the image region which includes the circular image so that the image region which includes the circular image is arranged in a center of the view display region 32. In addition, also in a case where the image data JD2 or JD3 is selected, the size changes in a similar way.

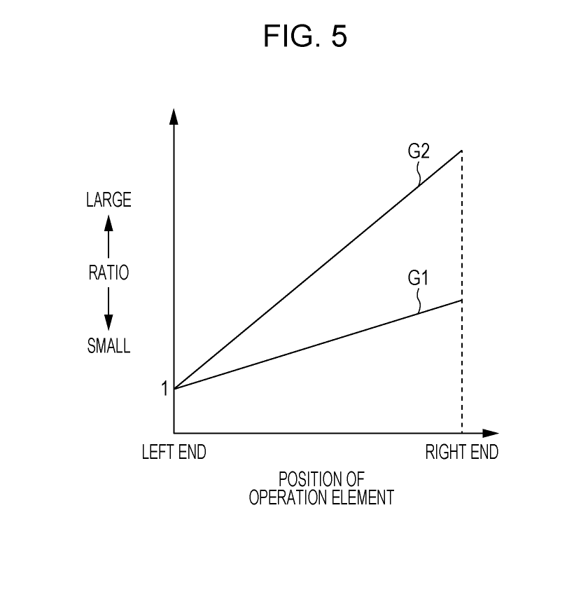

Herein, the enlargement and reduction ratio of the printing target data per unit movement amount of the operation element 51 on the first slide region 54, and the enlargement and reduction ratio of the image data per unit movement amount of the operation element 51 in the second slide region 55 are set to be different from each other. Specifically, as in the map illustrated in FIG. 5, the inclination of a graph G2 which indicates the enlargement and reduction ratio of the recording region RA of the image data per unit movement amount of the operation element 51 in the second slide region 55 is larger than the inclination of a graph G1 which indicates the enlargement and reduction ratio of the recording region RA of the image data per unit movement amount of the operation element 51 in the first slide region 54. The value of the enlargement and reduction ratio is determined so that the image region selected is entirely displayed in the pre-view 43 and has a maximum size when the operation element 51 is positioned in the left end of the second slide region 55. At this time, the enlargement and reduction ratio may be determined so that the entire height of the image region selected is displayed in the pre-view 43 when the vertically long image data is selected, and the entire width of the image region selected is displayed in the pre-view 43 when the laterally long image data is selected. The selected image regions may be multiple, and the value of the enlargement and reduction ratio is determined so that a plurality of the selected image regions is displayed in a state where a plurality of the selected image regions is within the pre-view 43. Thereby, since the enlargement and reduction ratio of the image region which is wanted to confirm the contents is appropriately determined, it is possible to perform the pre-view display with a size in which the user can easily confirm the contents with a small operation amount and to improve operation convenience for the user.

In a case where each view is switched by using the slider 50 of this configuration, the display control unit 14 (refer to FIG. 1) performs display form change processing which includes a change operation of the display form on the display window 31 and the enlargement and reduction operation of the recording regions RA of the image data in the layout view 42 and the pre-view 43.

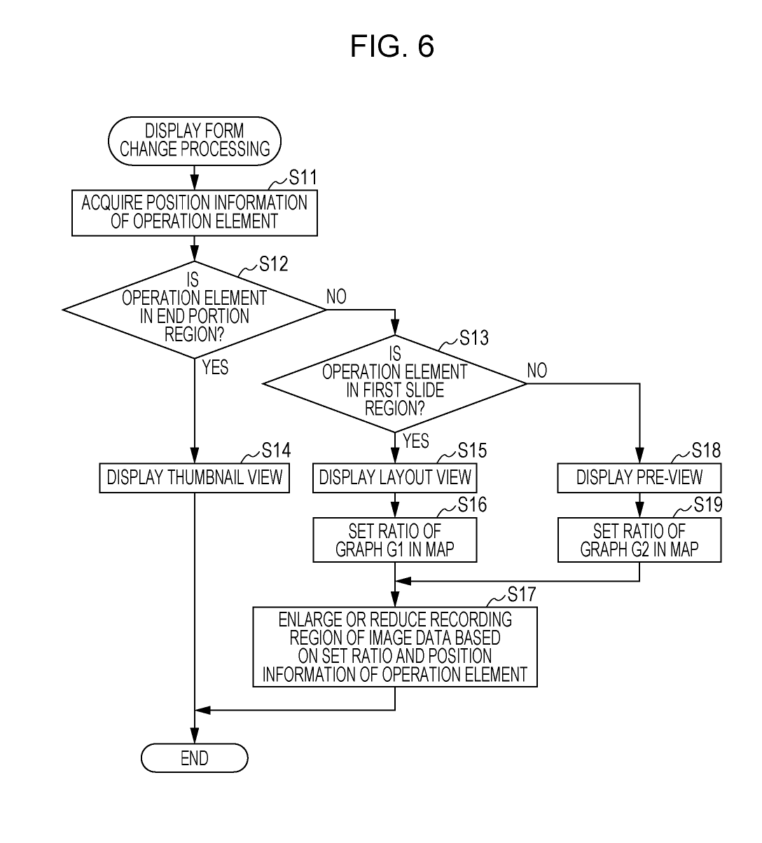

Hereinafter, referring to the flow chart of FIG. 6, detailed contents of the display form change processing will be described. In addition, in a below description, configuration elements of the printer server 11 which are denoted by reference numerals indicate the configuration elements of the printer server 11 in FIG. 1, and elements displayed in the setting screen 30 which are denoted by reference numerals indicate the elements displayed in the setting screen 30 in FIGS. 2 to 4B.

As illustrated in FIG. 6, the display control unit 14 firstly obtains the position information of the operation elements 51 of the slider 50 (Step S11), and determines where the operation element 51 is positioned from any one of the end portion region 53, the first slide region 54, and the second slide region 55 (Step S12 and S13).

Specifically, the display control unit 14 firstly determines whether the operation element 51 is positioned in the end portion region 53 or not (Step S12). Herein, when the display control unit 14 determines that the operation element 51 is positioned in the end portion region 53 (Step S12: YES), the display control unit 14 displays the thumbnail view 41 in the display window 31 (Step S14). On the other hand, when the display control unit 14 determines that the operation element 51 is not positioned in the end portion region 53 (Step S12: NO), the display control unit 14 determines whether the operation element 51 is positioned in the first slide region 54 or not (Step S13).

When the display control unit 14 determines that the operation element 51 is positioned in the first slide region 54 (Step S13: YES), the display control unit 14 displays the layout view 42 in the display window 31 (Step S15), and sets the enlargement and reduction ratio of the recording region RA of the image data based on the graph G1 of the map in FIG. 5 (Step S16). The display control unit 14 performs the enlargement or reduction of the recording region RA of the image data based on the set ratio and the position information of the operation element 51 (Step S17).

On the other hand, when the display control unit 14 determines that the operation element 51 is not positioned in the first slide region 54 (Step S13: NO), the display control unit 14 determines that the operation element 51 is positioned in the second slide region 55. The display control unit 14 displays the pre-view 43 in the display window 31 (Step S18), and sets the enlargement and reduction ratio of the recording region RA of the image data based on the graph G2 of the map in FIG. 5 (Step S19). The display control unit 14 proceeds to the Step S17 and performs the enlargement or reduction of the recording region RA of the image data.

However, the switching method of each view displayed in the display window 31 includes the switching using the slider 50 and the switching using tabs 41A, 42A, and 43A in the display window 31. When each view is switched by one of these switching methods, if the other of these switching methods is not interlocked, in some cases, the position of the operation element 51 and the view displayed in the display window 31 become different from each other.

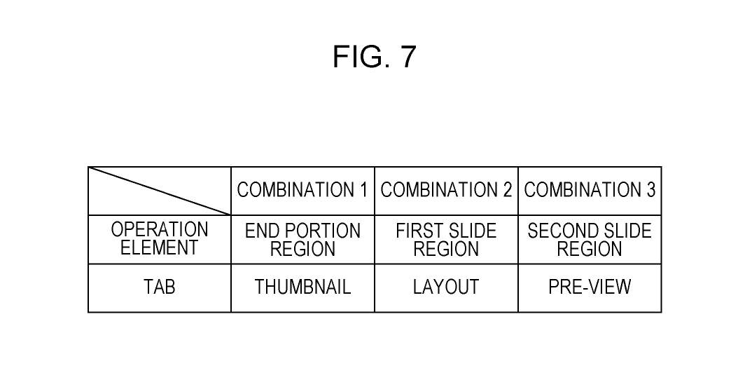

The display control unit 14 of the embodiment performs interlocking display processing so that the position of the operation element 51 and the selected tabs 41A, 42A, and 43A are interlocked. Specifically, the display control unit 14 interlocks the position of the operation element 51 and the selected tabs 41A, 42A, and 43A by using the table of combinations of the operation element 51 and the selected tabs 41A, 42A, and 43A illustrated in FIG. 7.

For this reason, for example, in a case where the display window 31 is the thumbnail view 41, when the user selects the tab 42A of the “layout”, the display control unit 14 moves the operation element 51 step by step or continuously from the end portion region 53 to the left end of the first slide region 54. In a case where the display window 31 is the layout view 42, when the user selects the tab 43A of the “pre-view”, the display control unit 14 moves the operation element 51 step by step or continuously from the first slide region 54 to the left end of the second slide region 55. Herein, the gradual movement of the operation element 51 is when the operation element 51 moves intermittently with predetermined intervals, and the continuous movement of the operation element 51 is that the operation element 51 moves without interruption.

On the other hand, when the user moves the operation element 51 from the end portion region 53 to the first slide region 54, the display control unit 14 changes the selection of the tab 41A of the “thumbnail” to the selection of the tab 42A of the “layout”. When the user moves the operation element 51 from the first slide region 54 to the second slide region 55, the display control unit 14 changes the selection of the tab 42A of the “layout” to the selection of the tab 43A of the “pre-view”. When the user directly selects the predetermined position of the first slide region 54, the display control unit 14 changes the selection to the selection of the tab 42A of the “layout”, moves the operation element 51 to a selected point, and displays the image region which is selected with the enlargement and reduction ratio according to the position of the selected first slide region 54. When the user directly selects the predetermined position of the second slide region 55, the display control unit 14 changes the selection to the selection of the tab 43A of the “pre-view”, moves the operation element 51 to a selected point, and displays the image region which is selected with the enlargement and reduction ratio according to the position of the selected second slide region 55.

Next, the operation of the printer server 11 of the embodiment configured as described above will be described.

Before the printer 70 starts recording of the image data on a continuous paper sheet, the user performs a confirmation operation of the confirmation of the number and order of the printing jobs, the layout confirmation of the image data to be printed on a continuous paper sheet, and the detailed confirmation of the image data to be printed on a continuous paper sheet in this order. If there is no problem in all of the confirmation operations, the user starts recording of the image data on a continuous paper sheet by the printer 70.

In this respect, when the printer server 11 is started, the setting screen 30 as illustrated in FIG. 2, that is, the thumbnail view 41 capable of the confirmation of the number and order of the printing jobs is displayed in the display unit 22 of the printer server 11. For this reason, the user can perform the confirmation of the number and order of the printing jobs. In addition, as illustrated in FIG. 2, the image data JD1 is selected by indicating a frame of the recording region RA by a thick-line in the thumbnail view 41.

When the user moves the operation element 51 of the slider 50 to the right side so that the operation element 51 is moved from the end portion region 53 to the first slide region 54, the displayed content on the setting screen 30 is switched from the thumbnail view 41 to the layout view 42. The user operates the operation element 51 in the first slide region 54 so that the recording regions RA of the image data JD1 to JD3 in the layout view 42 are enlarged or reduced. Thereby, the user can confirm the arrangement position or the orientation of the layout of the image data to be printed on the continuous paper sheet, that is, the recording regions RA of the image data JD1 to JD3.

When the user moves the operation element 51 to the right side so that the operation element 51 is moved from the first slide region 54 to the second slide region 55, the displayed content on the setting screen 30 is switched from the layout view 42 to the pre-view 43. The user operates the operation element 51 in the second slide region 55 so that the recording region RA of the image data JD1 in the pre-view 43 is enlarged or reduced. Thereby, the user can perform the detailed confirmation of the recording region RA of the image data JD1 to be printed on the continuous paper sheet.

In this manner, the thumbnail view 41, the layout view 42, and the pre-view 43 are switched based on the operation of one slider 50 and the above-described confirmation operation can be performed in order. Therefore, during the above-described confirmation operation in order, the required display window 31 is likely to be displayed on the display unit 22.

According to the printer server 11 of the embodiment, the effects described as follows can be obtained.

(1) The slider 50 can switch the thumbnail view 41, the layout view 42 and the pre-view 43, and can perform the enlargement or reduction in each of the layout view 42 and the pre-view 43. In this manner, since the user operates the slider 50 so that the enlargement or reduction can be performed in each of the layout view 42 and the pre-view 43, the operability of the user interface, that is, the operability of the slider 50 which is used in confirming the displayed image data which includes the recording region RA and information can be improved.

(2) The slide bar 52 is formed with the first slide region 54, and the second slide region 55 which are arranged side by side in a row in the lateral direction. For this reason, on the layout view 42 and the pre-view 43 in which the display forms of the recording region RA of the image data are different, the enlargement and reduction of the recording region RA of the image data displayed on the layout view 42 and the enlargement and reduction of the recording region RA of the image data displayed on the pre-view 43 are possible by the operation of the common slider 50. Therefore, in comparison with a case where an individual slider is displayed in each of the layout view 42 and the pre-view 43, the operability of the enlargement and reduction of the recording region RA of the image data on the layout view 42 and the pre-view 43 is improved.

(3) The printer server 11 is set so that the enlargement and reduction ratio of the recording region RA of the image data on the second slide region 55 and the enlargement and reduction ratio of the recording region RA of the image data on the first slide region 54 are different from each other. Thereby, according to a purpose of enlargement or reduction of the recording region RA of the image data or conditions, the first slide region 54 and the second slide region 55 can be properly used. Therefore, the operability of the enlargement and reduction of the recording region RA of the image data is improved.

(4) The printer server 11 is set so that the enlargement and reduction ratio of the recording region RA of the image data on the second slide region 55 is larger than the enlargement and reduction ratio of the recording region RA of the image data on the first slide region 54. The operation element 51 is operated on the first slide region 54 of the slide bar 52 in the layout view 42, and the operation element 51 is operated on the second slide region 55 in the pre-view 43. For this reason, the enlargement and reduction ratio of the recording region RA of the image data on the pre-view 43 becomes larger than the enlargement and reduction ratio of the recording region RA of the image data in the layout view 42. Therefore, the recording regions RA of the plurality of the image data in the layout view 42 can be gradually enlarged or reduced, and the recording region RA of one image data in the pre-view 43 can be rapidly enlarged or reduced. For this reason, the user can easily confirm the arrangement position of the recording regions RA of the plurality of the image data or the orientation of the recording region RA, and the detailed image in the recording region RA of one image data.

(5) The printer server 11 includes the selection unit 15A capable of selecting the recording region RA of the image data displayed in the display window 31. For this reason, the user can partially or entirely select the recording region RA which the user wants to confirm, and can enlarge and reduce the recording region RA by the selection unit 15A. For this reason, the user can easily confirm the information of the recording region RA.

(6) The portion of the recording region RA of the image data on the pre-view 43 is selected, for example, by the cursor, and the selected portion of the recording region RA is enlarged and reduced by the operation of the slider 50. For this reason, a portion of the recording region RA which the user wants to confirm can be selected, and can be enlarged and reduced. For this reason, the operability when the user confirms the image of the recording region RA is improved.

(7) When the portion of the recording region RA of the image data on the pre-view 43 is selected, for example, by the cursor, and the selected portion of the recording region RA is enlarged and reduced by the operation of the slider 50, the portion of the recording region RA is displayed in the center of the pre-view 43. Thereby, since the portion of the recording region RA which the user wants to confirm is displayed in the center of the pre-view 43, the operation which moves the enlarged recording region RA to the center of the pre-view 43 after the user enlarges the portion of the recording region RA can be omitted. For this reason, the user can easily confirm the portion of the recording region RA.

(8) The GUI control module 15 displays the tab 42A which displays the layout view 42 on the display window 31 and the tab 43A which displays the pre-view 43 on the display window 31, and can switch the layout view 42 and the pre-view 43 based on the selection of each tab 42A and 43A. For this reason, in comparison with a case where the layout view 42 and the pre-view 43 are switched by the operation of the slider 50, the layout view 42 and the pre-view 43 are rapidly switched.

(9) Based on the selection of each tab 41A, 42A, and 43A of the thumbnail view 41, the layout view 42, and the pre-view 43, the GUI control module 15 moves the operation element 51 of the slider 50 to a position of the slider region on the slide bar 52 corresponding to the selected tab. Thereby, since the operation to adjust the position of the operation element 51 after selecting each tab 41A, 42A, and 43A can be omitted, the operability of the enlargement and reduction of the recording region RA of the image data by the slider 50 after the switching of each view 41, 42, and 43 by each tab 41A, 42A, and 43A is improved.

(10) When each tab 41A, 42A, and 43A of the thumbnail view 41, the layout view 42, and the pre-view 43 are selected, the GUI control module 15 moves the operation element 51 step by step to a position of the slider region on the slide bar 52 corresponding to the selected tab. Thereby, since the user can confirm the movement of the operation element 51, the user can easily grasp whether the position of the operation element 51 corresponding to each view 41, 42, and 43 is correct or not.

(11) In the GUI control module 15, the display form of the end portion region 53 on the slide bar 52 of the slider 50, the display form of the first slide region 54 and the display form of the second slide region 55 are made different from each other. Thereby, the user can easily distinguish the end portion region 53 on the slide bar 52, the first slide region 54, and the second slide region 55. In addition, the length of the first slide region 54 and the length of the second slide region 55 are easily grasped. For this reason, the user can easily grasp the enlargement and reduction ratio of the recording region RA with respect to the position of the operation element 51 on each slide region 54 and 55.

(12) As illustrated in the slider 50 of FIGS. 2 to 4B, when the operation element 51 is positioned in the end portion region 53, the boundary between the end portion region 53 and the first slide region 54 is covered by the operation element 51. When the operation element 51 is positioned in the left end of the second slide region 55 or the right end of the first slide region 54, the boundary between the first slide region 54 and the second slide region 55 is covered by the operation element 51. For this reason, the user cannot see each boundary.

In this respect, in the embodiment, in the down side of the slide bar 52, a position display unit 56A which indicates the position of the operation element 51 on the end portion region 53 and a position display unit 56B which indicates the position of the operation element 51 of the left end of the second slide region 55 are displayed. For this reason, even when the boundary of each region of the slide bar 52 is not visible due to the operation element 51, the user can grasp the position of the operation element 51 with respect to each boundary by the position display units 56A and 56B. For this reason, since the view change which is different from an intention of the user is suppressed in accordance with the operation of the operation element 51, inconvenience of the user can be decreased.

The above-described embodiment may be changed to another embodiment as below.

According to the above-described embodiment, the shape of the position display units 56A and 56B may be changed to another shape such as a rod shape or the like, without being limited to a triangle as illustrated in FIGS. 2 to 4B.

According to the above-described embodiments, the lateral length of the first slide region 54 and the lateral length of the second slide region 55 on the slide bar 52 may be made different from each other. In this case, since it is preferable that the recording region RA of the image data on the pre-view 43 is enlarged to be larger than the recording region RA of the image data on the layout view 42, it is preferable that the lateral length of the second slide region 55 is increased to be larger than the lateral length of the first slide region 54.

According to the above-described embodiments, the shape of the slide bar 52 may be displayed with at least one of the end portion region 53, the first slide region 54, and the second slide region 55 having a shape different from the rod shape. For example, at least one of the end portion region 53, the first slide region 54, and the second slide region 55 may be displayed in the triangle such as an isosceles triangle formed with an apex angle in the right end or left end. At least one of the end portion region 53, the first slide region 54, and the second slide region 55 may be displayed in a rhombus shape in which a diagonal line extends in the lateral direction and the vertical direction.

According to the above-described embodiments, at least two or more of the end portion region 53, the first slide region 54, and the second slide region 55 may be different from each other in the width in the vertical direction. According to this configuration, the user can easily recognize the boundary between the end portion region 53 and the first slide region 54 and the boundary between the first slide region 54 and the second slide region 55.

According to the above-described embodiments, when the position display units 56A and 56B are displayed, the display forms of the end portion region 53, the first slide region 54, and the second slide region 55 may be equal to each other.

According to the above-described embodiments, the enlargement and reduction ratio of the recording region RA of the image data per unit movement amount of the operation element 51 on each of the slide regions 54 and 55 can be arbitrarily set. However, it is preferable that the enlargement and reduction ratio of the recording region RA of the image data per unit movement amount of the operation element 51 on the second slide region 55 is larger than the enlargement and reduction ratio of the recording region RA of the image data per unit movement amount of the operation element 51 on the first slide region 54. The user may change the setting of the enlargement and reduction ratio of the recording region RA of the image data per unit movement amount of the operation element 51 on each of the slide regions 54 and 55.

According to the above-described embodiments, the center at the time when the recording region RA of the image data on the layout view 42 and the pre-view 43 is enlarged and reduced can be arbitrarily set. For example, the center at the time when the recording region RA of the image data on the layout view 42 and the pre-view 43 is enlarged and reduced may be set in the upper left portion of the view display region 32.

According to the above-described embodiments, the tab 41A of the thumbnail, the tab 42A of the layout, and the tab 43A of the pre-view on the display window 31 may be omitted. In this case, the interlocking display processing from the display control unit 14 is omitted.

According to the above-described embodiments, by lengthening the end portion region 53 of the slide bar 52, the recording regions RA of the image data JD1 to JD3 may be enlarged and reduced based on the operation of the operation element 51 on the thumbnail view 41.

According to the above-described embodiments, a combination of correspondence between the thumbnail view 41, the layout view 42, and the pre-view 43 and the end portion region 53, the first slide region 54, and the second slide region 55 on the slide bar 52 can be arbitrarily changed.

According to the above-described embodiments, when the operation element 51 is positioned in each of the end portion region 53, the first slide region 54, and the second slide region 55, the display form such as color, size, shape or the like of the operation element 51 may be changed. As an example thereof, when the operation element 51 is positioned in the end portion region 53, the shape of the operation element 51 is the circular shape. When the operation element 51 is moved from the end portion region 53 to the first slide region 54, the shape of the operation element 51 is changed from the circular shape to the triangle. When the operation element 51 is moved from the first slide region 54 to the second slide region 55, the shape of the operation element 51 is changed from the triangle to the square.

For example, the slider 50 may be applied in the user interface capable of switching of the continuous screen, without being limited to the switching of the display forms of the thumbnail view 41, the layout view 42, and the pre-view 43.

According to the above-described embodiments, when the layout button 34A is selected, on the other screen than the display window 31 of the setting screen 30, as a dedicated screen, the screen of the “thumbnail” may be displayed. The “thumbnail”, “layout” or “pre-view” may be displayed on the dedicated screen to be able to be selected, for example, by the tab or the like. By selecting the “thumbnail”, “layout” or “pre-view” on the dedicated screen, the screen of the “thumbnail”, “layout” or “pre-view” may be displayed on the dedicated screen. The display of the “thumbnail”, “layout” or “pre-view” may be switched according to the operation of the slide bar 52. By selecting the “thumbnail”, “layout” or “pre-view” on the dedicated screen, the position of the slide bar 52 on the display window 31 may be changed.

Without being limited to the continuous paper sheet, the medium may be a cut sheet, a resin film, a metal foil, a metal film, a metal-resin composite film (a laminated film), a woven fabric, a nonwoven fabric, a ceramic sheet or the like.

The entire disclosure of Japanese Patent Application No. 2015-116402, filed Jun. 9, 2015 is expressly incorporated by reference herein.

What is claimed is:

1. A display control device comprising:
a display unit that can display a recording region which indicates an area in a medium in which information is recorded and the information to be recorded in the recording region; and
a display control unit that controls display contents of the display unit,
wherein the display control unit causes the display unit to display the recording region and the information in each of a first display form and a second display form which are display forms different from each other, and causes the display unit to display a slider that can perform an enlargement and reduction operation of the recording region in each of the first display form and the second display form, and a switching operation between the first display form and the second display form.

2. The display control device according to claim 1,
wherein the slider includes an operation element that can move by an operation and a slide bar that indicates a movable range of the operation element, and
wherein the slide bar is formed with a first slide region as a movable range of the operation element for the enlargement and reduction of the recording region in the first display form, and a second slide region as a movable range of the operation element for the enlargement and reduction of the recording region in the second display form, which are arranged side by side in a row.

3. The display control device according to claim 2,
wherein an enlargement and reduction ratio of the recording region per unit movement amount of the operation element in the first slide region is different from an enlargement and reduction ratio of the recording region per unit movement amount of the operation element in the second slide region.

4. The display control device according to claim 3,
wherein the enlargement and reduction ratio of the recording region per unit movement amount of the operation element in the second slide region is larger than the ratio in the first slide region,
wherein the first display form is a layout view that indicates an arrangement form of the recording region with respect to the medium, and
wherein the second display form is a pre-view that indicates detailed information of the recording region.

5. The display control device according to claim 4,
wherein the display control unit includes a selection unit that can select the recording region which is displayed in the display unit.

6. The display control device according to claim 5,
wherein, when the operation element is operated in the first slide region, the display control unit enlarges or reduces the recording region that is displayed in the layout view centering on the recording region which is selected by the selection unit.

7. The display control device according to claim 5,
wherein, when the selection unit selects a portion of the recording region that is displayed in the display unit and the operation element is operated in the second slide region, the display control unit enlarges or reduces the recording region that is selected by the selection unit centering on the portion of the recording region which is selected by the selection unit.

8. The display control device according to claim 4,
wherein the display control unit causes the display unit to display a layout tab which displays the layout view in the display unit and a pre-view tab which displays the pre-view in the display unit, and can switch the layout view and the pre-view based on the selection between the layout tab and the pre-view tab.

9. The display control device according to claim 8,
wherein the display control unit moves the operation element to a position of the slide region corresponding to the selected tab based on the selection between the layout tab and the pre-view tab.

10. The display control device according to claim 9,
wherein, when the layout tab and the pre-view tab are switched, the display control unit moves the operation element step by step to a position of the slide region corresponding to the switched tab.

11. The display control device according to claim 2,
wherein the display control unit sets the display form of the first slide region and the display form of the second slide region to be different from each other.
